(19) United States
(12) Patent Application Publication
(10) Pub. No.: US 2023/0221768 A1
(43) Pub. Date: Jul. 13, 2023

(54) ELECTRONIC DEVICE AND SCREEN CONTROL METHOD THEREOF

(71) Applicant: ASUSTEK COMPUTER INC., TAIPEI (TW)

(72) Inventors: Chien-Hsin LIU, TAIPEI (TW); Yihsuan LEE, TAIPEI (TW)

(21) Appl. No.: 18/073,335

(22) Filed: Dec. 1, 2022

Related U.S. Application Data
(60) Provisional application No. 63/299,183, filed on Jan. 13, 2022.

(30) Foreign Application Priority Data
Sep. 23, 2022 (TW) 111136030

(51) Int. Cl. G06F 1/16; G06F 3/01

(52) U.S. Cl. CPC G06F 1/1652; G06F 3/01

(57) ABSTRACT

An electronic device is provided, including a flexible display element, an extending mechanism, a memory, an input unit, and a control unit. The extending mechanism is coupled to the flexible display element and configured to extend the flexible display element along a first direction. The memory stores a program list. The input unit receives an enable signal, where the enable signal corresponds to an application program. The control unit is electrically coupled to the flexible display element, the memory, and the input unit and is configured to determine whether the application program is included in the program list or not; and control, when the application program is included in the program list, the extending mechanism to extend the flexible display element along the first direction. The disclosure further provides a screen control method.

### CROSS-REFERENCE TO RELATED APPLICATIONS

This application program claims the priority benefit of U.S. provisional application Ser. No. 63/299,183, filed on Jan. 13, 2022, and Taiwan application serial No. 111136030, filed on Sep. 23, 2022. The entireties of the above-mentioned patent applications are hereby incorporated by reference herein and made a part of the specification.

### BACKGROUND OF THE DISCLOSURE

### Field of the Invention

The disclosure relates to an electronic device and a screen control method thereof, and in particular, to an electronic device and a screen size control method thereof.

### Description of the Related Art

With the progress of science and technology, requirements of users are increasingly diverse. When using electronic devices, the users require different sizes of screens according to different use states. How to make the screen size of the electronic device adjustable according to user requirements is a research direction in this field.

### BRIEF SUMMARY OF THE INVENTION

The disclosure provides a screen control method, applied to an electronic device. The electronic device includes a flexible display element and a program list. The screen control method includes: receiving an enable signal, where the enable signal corresponds to an application program; determining whether the application program is included in the program list or not; and extending the flexible display element along a first direction when the application program is included in the program list.

The disclosure further provides an electronic device. The electronic device includes a flexible display element, an extending mechanism, a memory, an input unit, and a control unit. The extending mechanism is coupled to the flexible display element and configured to extend the flexible display element along a first direction. The memory stores a program list. The input unit receives an enable signal, where the enable signal corresponds to an application program. The control unit is electrically coupled to the flexible display element, the memory, and the input unit and is configured to determine whether the application program is included in the program list or not; and control, when the application program is included in the program list, the extending mechanism to extend the flexible display element along the first direction.

In the electronic device and the screen control method thereof provided in the disclosure, a program list of to-be-extended-to screen sizes is preset. When an enable signal is received, it is determined whether an application program corresponding to the enable signal is included in the program list or not. When it is determined that the application program is included in the program list, the flexible display element is extended along the first direction to meet an operation requirement of a user when the application program is run.

### BRIEF DESCRIPTION OF THE DRAWINGS

FIG. 1 is a schematic block diagram of an electronic device according to an embodiment of the disclosure;

FIG. 2A and FIG. 2B are schematic diagrams of an embodiment of an extending mechanism according to the disclosure;

FIG. 3 shows a first embodiment of a flexible display element extending to a second length along a first direction according to the disclosure;

FIG. 4 shows a second embodiment of a flexible display element extending to a second length along a first direction according to the disclosure;

FIG. 5 shows a third embodiment of a flexible display element extending to a second length along a first direction according to the disclosure;

FIG. 6 is a flowchart of a screen control method according to an embodiment of the disclosure;

FIG. 7 is a flowchart of a screen control method according to another embodiment of the disclosure; and

FIG. 8 is a flowchart of a screen control method according to still another embodiment of the disclosure.

### DETAILED DESCRIPTION OF THE EMBODIMENTS

More detailed descriptions of specific embodiments of the disclosure are provided below with reference to the schematic diagrams. The features and advantages of the disclosure are described more clearly according to the following description and the scope of claims. It should be noted that all of the drawings use very simplified forms and imprecise proportions, only being used for assisting in conveniently and clearly explaining the objective of the embodiments of the disclosure.

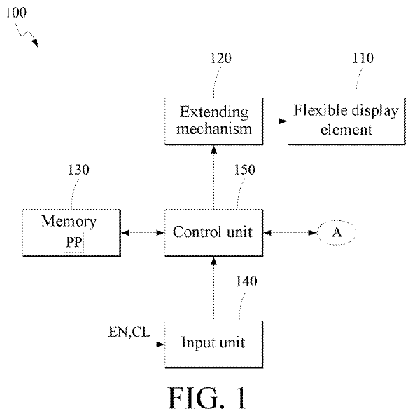

FIG. 1 is a schematic block diagram of an electronic device 100 according to an embodiment of the disclosure. In an embodiment, the electronic device 100 is a notebook computer. The disclosure is applied to another electronic device 100 having a flexible display element 110, and in an embodiment, is a foldable smartphone, a tablet computer, a portable screen, or the like.

As shown in the figure, the electronic device 100 includes a flexible display element 110, an extending mechanism 120, a memory 130, an input unit 140, and a control unit 150.

The extending mechanism 120 is coupled to the flexible display element 110 and configured to extend the flexible display element 110. In an embodiment, the flexible display element 110 is an organic light-emitting diode (OLED) display. In an embodiment, the extending mechanism 120 extends along a long-side direction of the flexible display element 110, and extends a display range of the flexible display element 110 from a 4:3 aspect ratio to a 16:9 aspect ratio. Structural details of the extending mechanism 120 are described more specifically in the following paragraphs.

The memory 130 stores a program list PP. The program list PP includes an index of a plurality of application programs. The application programs are programs, such as an audio-video editing program, a game program, and a browser program, adapted to being run in cooperation with the extended flexible display element 110. In an embodiment, the application programs listed in the index are set by a user according to requirements of the user.

The input unit 140 is configured to receive an enable signal EN to enable an application program A. The input unit 140 is a keyboard, a touch pad, a touch module integrated into the flexible display element 110, or the like. The enable signal EN is a key signal or a touch signal.

The control unit 150 is electrically coupled to the flexible display element 110, the memory 130, and the input unit 140. The control unit 150 determines the enabled application program A according to the enable signal EN, and further determines whether the application program A is included in the program list PP or not. When the application program A is included in the program list PP, the control unit 150 controls the extending mechanism 120 to extend the flexible display element 110. In an embodiment, the control unit 150 is a central processing unit (CPU), a graphics processing unit (GPU), a microprocessor (MCU), or the like.

In an embodiment, the input unit 140 is further configured to receive a closing signal CL to close the application program A. The closing signal CL is a key signal or a touch signal, or is a signal generated when the electronic device 100 is not used for a period of time and enters a sleep mode. The control unit 150 controls, according to the closing signal CL, the extending mechanism 120 to retract the flexible display element 110 to an original size thereof.

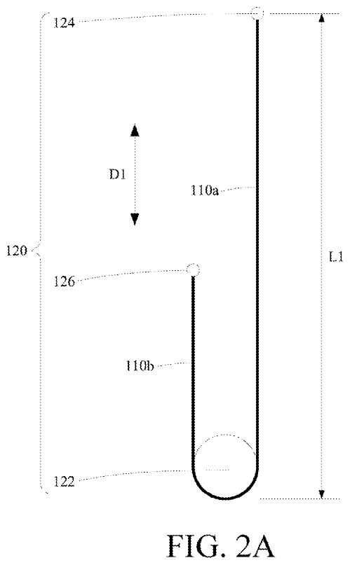

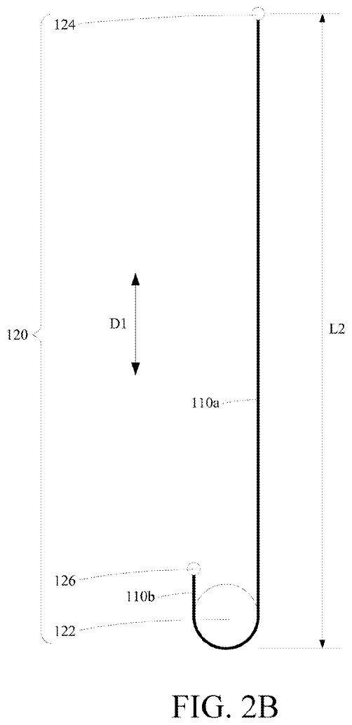

Referring to FIG. 2A and FIG. 2B together, FIG. 2A and FIG. 2B are schematic diagrams of an embodiment of an extending mechanism 120 according to the disclosure. The extending mechanism 120 extends the flexible display element 110 from a first length L1 to a second length L2 along a first direction D1.

As shown in the figure, the extending mechanism 120 includes a fixed end 122, a first movable end 124, and a second movable end 126. The first movable end 124 and the second movable end 126 are movable relative to the fixed end 122 along the first direction D1. Two opposite sides of the flexible display element 110 are respectively connected to the first movable end 124 and the second movable end 126. A middle section of the flexible display element 110 is wound around the fixed end 122. A part of flexible display element 110 located between the fixed end 122 and the first movable end 124 is a display part 110a of the flexible display element 110, forming a display range of the flexible display element 110. A part of the flexible display element 110 located between the fixed end 122 and the second movable end 126 is a retracted part 110b of the flexible display element 110.

As shown in FIG. 2A, when the flexible display element 110 is in a retracted state, the flexible display element 110 has the first length L1, and the retracted part 110b is hidden behind the display part 110a.

Also referring to FIG. 2B, when the flexible display element 110 needs to be extended to the second length L2, the first movable end 124 moves away from the fixed end 122 to increase a size of the display part 110a, and the second movable end 126 is driven by the first movable end 124 to gradually approach the fixed end 122.

In an embodiment, when a length of the flexible display element 110 is the first length L1, an aspect ratio of the display part 110a of the flexible display element 110 is 4:3. When the length of the flexible display element 110 is the second length L2, the aspect ratio of the display part 110a of the flexible display element 110 is 16:9.

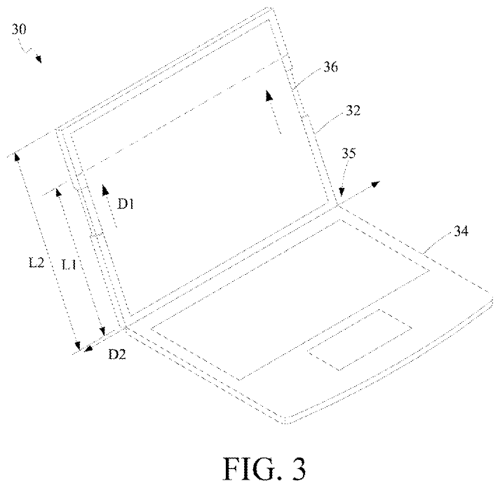

FIG. 3 shows a first embodiment of a flexible display element 36 extending to a second length L2 along a first direction D1. A dashed line in the figure shows a size of the flexible display element 36 before the extending.

An electronic device 30 in the figure is a notebook computer, including a first body 32 and a second body 34. The first body 32 is pivotally connected to the second body 34 by a rotating shaft 35. The flexible display element 36 is located in the first body 32.

The flexible display element 36 is extended from the first length L1 to the second length L2 along the first direction D1 by the extending mechanism (not shown in the figure). The first direction D1 is perpendicular to an axial direction D2 of the rotating shaft 35. That is, the flexible display element 36 in this embodiment is extended along a vertical direction to increase a display area.

In an embodiment, when the flexible display element 36 is in a retracted state, an aspect ratio of a display range of the flexible display element 36 is 9:16, presenting a display ratio of a wide screen.

When the flexible display element 36 is in an extended state, a vertical size of the flexible display element 36 is increased from the first length L1 to the second length L2, the aspect ratio thereof becomes 3:4, thereby presenting a display range closer to a square to increase the display area in the vertical direction. The display mode is adapted to application programs in which a window needs to be pulled up and down frequently to view content, such as a browser program, an audio-video editing program, and a special effect creation program.

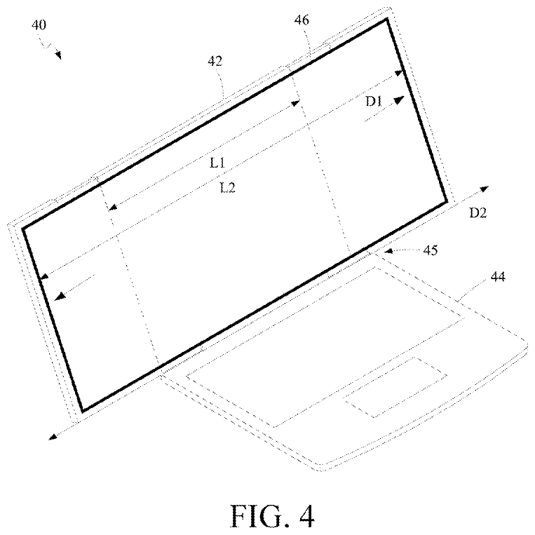

FIG. 4 shows a second embodiment of a flexible display element 46 extending to a second length L2 along a first direction D1. Dashed lines in the figure show a size of the flexible display element 46 before the extending.

An electronic device 40 in the figure is a notebook computer, including a first body 42 and a second body 44. The first body 42 is pivotally connected to the second body 44 by a rotating shaft 45. The flexible display element 46 is located in the first body 42.

The flexible display element 46 is extended from the first length L1 to the second length L2 along the first direction D1 by the extending mechanism (not shown in the figure). The first direction D1 is perpendicular to an axial direction D2 of the rotating shaft 45. That is, the flexible display element 46 in this embodiment is extended along a lateral direction to increase a display area. In an embodiment, as shown in the figure, the extending mechanism (not shown in the figure) extends a left side and a right side of the flexible display element 46 outward to increase a display area.

In an embodiment, when the flexible display element 46 is in a retracted state, an aspect ratio of a display range of the flexible display element 46 is 4:3. When the flexible display element 46 is in an extended state, a lateral size of the flexible display element 46 is increased from the first length L1 to the second length L2, so that the aspect ratio of the display range thereof becomes 16:9, thereby presenting a display ratio of a wide screen to increase the display area in the lateral direction. This display mode is adapted to application programs of which a lateral display range needs to be increased, such as a game program, an audio-video playback program, and an audio-video editing program.

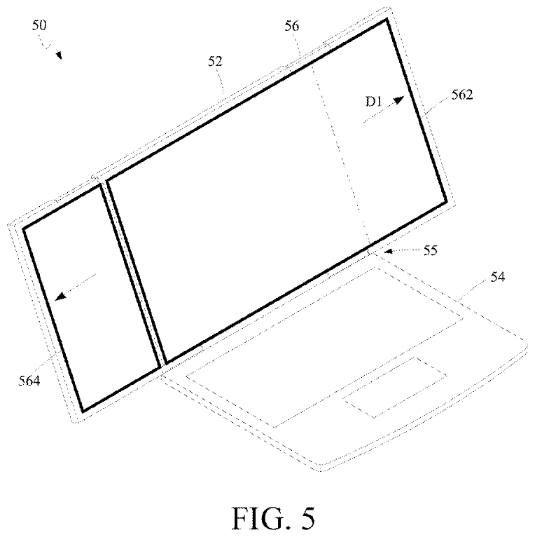

FIG. 5 shows a third embodiment of a flexible display element 56 extending to a second length L2 along a first direction D1. Dashed lines in the figure show a size of the flexible display element 56 before the extending.

An electronic device 50 in the figure is a notebook computer, including a first body 52 and a second body 54. The first body 52 is pivotally connected to the second body 54 by a rotating shaft 55. The flexible display element 56 is located in the first body 52.

An extending direction of the flexible display element 56 in this embodiment is similar to that of the flexible display element 46 in the embodiment of FIG. 4. Details are not described herein.

This embodiment mainly differs from the embodiment of FIG. 4 in respect of a presentation manner of the extended flexible display element 56.

In the embodiment of FIG. 4, a screen of the application program A is enlarged to fill up the display range of the extended flexible display element 56. In this embodiment, the extended flexible display element 56 is divided into a main window 562 and a sub-window 564. The screen of the application program A that triggers the extending mechanism (not shown in the figure) to extend the flexible display element 56 fills up the main window 562. Screens of other application programs are presented in the sub-window 564. In an embodiment, a size of the main window 562 is larger than a size of the sub-window 564. The size or position of the main window 562 corresponds to the display range of the flexible display element 56 before the extending.

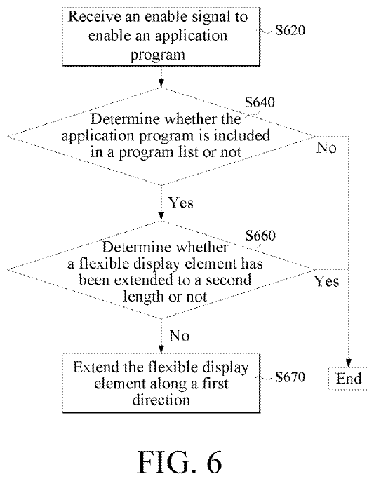

FIG. 6 is a flowchart of a screen control method according to an embodiment of the disclosure. The screen control method is applied to the electronic device 100 shown in FIG. 1. The electronic device 100 includes a flexible display element 110 and a program list PP. The screen control method includes the following steps.

First, as described in step S620, an enable signal EN is received to enable an application program A.

Then, as described in step S640, it is determined whether the application program A is included in the program list PP or not.

When the application program A is not included in the program list PP, the process ends. When the application program A is included in the program list PP, the process proceeds to step S660, to determine whether the flexible display element 110 has been extended to the second length L2 or not.

When the flexible display element 110 has been extended to a second length L2, the process ends. When the flexible display element 110 has not been extended to the second length L2, the process proceeds to step S670, to extend the flexible display element 110 along a first direction D1.

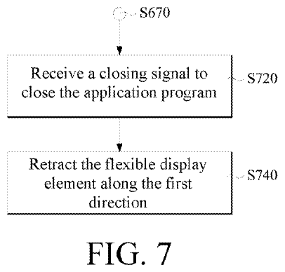

FIG. 7 is a flowchart of a screen control method according to another embodiment of the disclosure. The screen control method is applied to the electronic device 100 shown in FIG. 1.

Following step S670 in FIG. 6, when the flexible display element 110 has been extended to the second length L2, as described in step S720, a closing signal CL is received to close the application program A. The application program is the application program A enabled in the foregoing step S620.

Then, as described in step S740, the flexible display element 110 is retracted along the first direction D1.

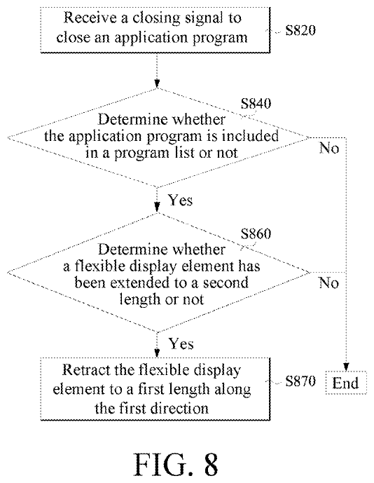

FIG. 8 is a flowchart of a screen control method according to still another embodiment of the disclosure. The screen control method is applied to the electronic device 100 shown in FIG. 1. The electronic device 100 includes a flexible display element 110 and a program list PP. The electronic device 100 has enabled an application program A.

First, as described in step S820, a closing signal CL is received to close the application program A.

Then, as described in step S840, it is determined whether the application program A is included in the program list PP or not.

When the application program A is not included in the program list PP, the process ends. When the application program A is included in the program list PP, the process proceeds to step S860, to determine whether the flexible display element 110 has been extended to the second length L2 or not.

When the flexible display element 110 has been extended to the second length L2, the process proceeds to step S870, the flexible display element 110 is retracted to a first length L1 along a first direction D1. When the flexible display element 110 has not been extended, the process ends.

The foregoing embodiments describe a technology of extending the flexible display element 110 from the first length L1 to the second length L2 along the first direction D1 and shortening the flexible display element 110 from the second length L2 to the first length L1. In an embodiment, the control unit 150 sets another positioning position besides the first length L1 and the second length L2 to control an extending distance of the flexible display element 110. The program list PP stored in the memory 130 further includes, in addition to an index of application programs, display sizes corresponding to the application programs. After determining the enabled application program, the control unit 150 controls the extending mechanism 120 to extend the flexible display element 110 to a required length according to a display size corresponding to the enabled application program.

In an embodiment, it is assumed that the aspect ratio of the display range corresponding to the first length L1 is 9:16, and the aspect ratio of the display range corresponding to the second length L2 is 3:4. The control unit 150 further sets another positioning position corresponding to a display range of which an aspect ratio is 10:16, to control the extending distance of the flexible display element 110. The program list PP records a plurality of application programs and display sizes (one is selected from the foregoing aspect ratios of 9:16, 3:4, and 10:16) corresponding to the application programs.

In the electronic device 100 and the screen control method thereof provided in the disclosure, a program list PP of to-be-extended-to screen sizes is preset. When an enable signal EN is received, it is determined whether an application program corresponding to the enable signal EN is included in the program list PP or not. When it is determined that the application program is included in the program list PP, the flexible display element 110 is extended along the first direction D1 to meet an operation requirement of a user when the application program is run.

The foregoing descriptions are merely exemplary embodiments of the disclosure and are not intended to limit the disclosure in any way. Any person skilled in the art can make any form of equivalent replacement or modification to the technical means and technical contents in the disclosure without departing from the scope of the technical means of the disclosure, and such equivalent replacement or modification does not depart from the contents of the technical means of the disclosure and still falls within the protection scope of the disclosure.

What is claimed is:

1. A screen control method, applied to an electronic device, wherein the electronic device comprises a flexible display element and a program list, the screen control method comprising:
receiving an enable signal to enable an application program;
determining whether the application program is included in the program list or not; and
extending the flexible display element along a first direction when the application program is included in the program list.

2. The screen control method according to claim 1, wherein the electronic device comprises a first body and a second body, the first body is pivotally connected to the second body along a second direction, the flexible display element is located in the first body, and the first direction is perpendicular to the second direction.

3. The screen control method according to claim 1, wherein the electronic device comprises a first body and a second body, the first body is pivotally connected to the second body along a second direction, the flexible display element is located in the first body, and the first direction is parallel to the second direction.

4. The screen control method according to claim 1, further comprising:
receiving a closing signal to close the application program; and
retracting the flexible display element along the first direction when the flexible display element has been extended.

5. The screen control method according to claim 1, wherein when the application program is included in the program list, the flexible display element is extended from a first length to a second length along the first direction.

6. The screen control method according to claim 5, wherein when a length of the flexible display element is the first length, an aspect ratio of the flexible display element is 9:16, and when the length of the flexible display element is the second length, the aspect ratio of the flexible display element is 3:4.

7. The screen control method according to claim 1, further comprising: dividing the extended flexible display element into a main window and a sub-window.

8. The screen control method according to claim 7, wherein the main window corresponds to the flexible display element before the extending.

9. An electronic device, comprising:
a flexible display element;
an extending mechanism, coupled to the flexible display element and configured to extend the flexible display element along a first direction;
a memory, configured to store a program list;
an input unit, configured to receive an enable signal, wherein the enable signal is used for enabling an application program;
a control unit, electrically coupled to the flexible display element, the memory, and the input unit, and configured to:
determine whether the application program is included in the program list or not; and
control, when the application program is included in the program list, the extending mechanism to extend the flexible display element along the first direction.

10. The electronic device according to claim 9, wherein the extending mechanism is configured to extend the flexible display element from a first length to a second length along the first direction, and when the application program is included in the program list, the control unit controls the extending mechanism to extend the flexible display element from the first length to the second length along the first direction.
